(19) United States
(12) Patent Application Publication
(10) Pub. No.: US 2005/0123193 A1
(43) Pub. Date: Jun. 9, 2005

(54) Image adjustment with tone rendering curve

(75) Inventors: Markku Lamberg, Kerava (FI); Joni Oja, Kerava (FI); Tero Vuori, Vantaa (FI); Kristina Bjorknas, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/729,872

(22) Filed: Dec. 5, 2003

(51) Int. Cl. G06K 9/00; G06K 9/40

(52) U.S. Cl. 382/167; 382/274

(57) ABSTRACT

The invention relates to a method for rendering images on display devices with improved quality. To allow adjusting luminance values of pixels depending on image information, it is proposed that contents of said image are analysed at least partially, a tone rendering curve based on said analysed image content is determined and luminance values of pixels within said image are adjusted according to said determined tone rendering curve.

### TECHNICAL FIELD

The invention relates to a method for rendering images on display device with improved quality. The invention also relates to a display device for presenting images to viewers, a display device driver for driving such a display, and a system for presenting images with improved quality. Furthermore, the invention relates to a computer program and a computer program product.

### BACKGROUND

It is common knowledge that different tone rendering curves (commonly called gamma) are provided for different display devices. It is also known, that there are “standard” gamma values for personal computers or Apple Macintosh computers. In particular, displaying images on cathode-ray tubes (CRT) strongly depends on its brightness and contrast set-up as well as ambient light.

The luminance of pixels produced by these displays is not directly linearly proportional to the input signal for a pixel. In case of a cathode-ray tube, a 50% increase in input signal only leads to an 18% increase in brightness. The output signal may be adjusted according to an exponential relationship, where the brightness is equal to the input raised to the power of the value of the tone rendering curve. The output luminance value can be calculated as:

$${I}_{output} = {( \frac{{D}_{input}}{255} )}^{γ} \times 255$$

With I representing a brightness output value of a pixel, D an input value for a pixel, and γ a value of a tone rendering curve.

From “Graphic Arts in Finland”, Volume 24, No. 1, Graphic Arts Research Foundation, Laihanen, it is known that digital images may be optimised by manipulating pixel values in different colour models. This publication proposes to use tone rendering curves for adjusting pixel values to improve image quality. To avoid changes in the colour components, different colour models are proposed. In general, any colour model may be used. In particular in the HSV (hue, saturation, value) model it is proposed to adjust only value and keep hue, and keep saturation unchanged. According to this HSV colour model, it is possible to change pixel brightness without changing colour components.

In the above mentioned publication it is also proposed to use an Lsα colour model to improve image quality by adjusting pixel values according to a tone rendering curve.

However, it is difficult to find an optimum tone rendering curve. Image quality, e.g. the way pixels are perceived by viewers, and what their impression concerning quality is, strongly depends on content and external illumination. Also, device properties influence image quality and the way pixel values should be adjusted with a tone rendering curve.

### BRIEF SUMMARY OF THE INVENTION

The invention proposes to render images on display devices with the steps of analysing at least partially contents of said image, determining a tone rendering curve based on said analysed image content, and adjusting luminance values of pixels within said image according to said determined tone rendering curve.

One advantage of the inventive method is that by analysing the image content, the image itself may account for a tone rendering curve used for adjusting pixel values. Since a small gamma boosts the brightness, dark images need a smaller gamma compared to bright images.

By determining the tone rendering curve based on said analysed image content, for each image the optimum tone rendering curve may be found. Image manipulation may then be adjusted dynamically according to image content.

In particular, it is proposed that luminance values of pixels are analysed for determining an appropriate tone rendering curve. By this, the luminance of the image itself, e.g. the pixels within the image, may be used for determining the optimum tone rendering curve.

As the brightness of an image is crucial for choosing the correct tone rendering curve, it is proposed that an image histogram is analysed for determining said tone rendering curve. Said image histogram may show brightness distribution of pixels within an image, and according to this distribution, the correct tone rendering curve may be determined.

It is also possible to provide pre-defined tone rendering curves within look-up tables. These pre-defined tone rendering curves may also be specifically adjusted and optimised for a current display device. In case pre-defined tone rendering curves are used, it is proposed that at least two different tone rendering curves are stored and the determined tone rendering curve may then be taken from said storage. After analysing the content of the image, the best fitting tone rendering curve may be chosen. Nevertheless, it is also possible to calculate the tone rendering curve immediately after analysing the image, thus adopting the tone rendering curve according to the present image dynamically.

To account for certain display properties, such as which kind of display technology is used e.g. CRT, LCD, OLED, etc., as well as to which settings for brightness, contrast, or colour are chosen within the display, it is proposed that the tone rendering curve is customised according to properties of said display.

To avoid distortion of colour values, it is proposed that said tone rendering curve is applied to said luminance values of pixels within any device independent colour space, e.g. HSV or Lsα colour space. Deriving luminance as well as chromaticity components from RGB values, or HSV (hue, situation, value) or Lsα components from RGB values is common knowledge, and described in “Graphic Arts in Finland”.

Exemplarily, in an embodiment with a HSV or Lsα colour space model, it has been found that even when a non-linear tone rendering curve is used, the relation between RGB components may be maintained in case only Value is changed, and Hue, and Saturation remain unchanged. The L value within Lsα colour space approximates the brightness (or lightness) of a pixel, and can be calculated from

$$L = \frac{V}{{V}_{max} + {V}_{plus}} ,$$

V=k₁R+k₂G+k₃B,
Vₘₐₓ=V/max (R, G, VB)
Vₚₗᵤₛ=α(1−Vₘₐₓ) and
   where:
α=user definable constant,
k₁₊+k₂+k₃=1 and
k₁, k₂, k₃, R, G, B and αε[0,1]

When only changing this L value within Lsα colour space, the overall colour impression of an image remains unchanged, even when applying a non-linear tone rendering curve to the L value. The above mentioned colour space models do only describe exemplarily one possible embodiment. Any other colour space model used is within the scope of the invention. In any model it may be possible to use a nonlinear tone rendering curve when applied to the luminance value only.

The image impression may also be influenced by the environment of the display, in particular the ambient light, of the display. Therefore, it is proposed that ambient light information is acquired, and that said tone rendering curve is also determined based on said ambient light information. By that, effects of ambient light to image quality may be accounted for. The tone rendering curve may differ for a display depending on the lighting conditions.

Another aspect of the invention is a display device for presenting image to viewers, said display device comprising a screen for showing said image, image analysing means for analysing at least partially contents of said image, tone rendering curve determination means for determining a tone rendering curve based on said analysed image content, and image adjusting means for adjusting luminance values of pixels within said image according to said determined tone rendering curve. Said image analysing means may analyse the brightness of pixels within the image, e.g. by using a brightness histogram. Also, other properties of said image may be analysed. Said tone rendering curve determination means may use information of said image analysing means and may determine the optimum tone rendering curve. This may be done by calculation the tone rendering curve, or by using a pre-defined tone rendering curve stored within the storage.

A further aspect of the invention is a display device for presenting images to viewers, said display device comprising a screen for showing said image, ambient light acquisition means for acquiring ambient light information, tone rendering curve determination means for determining a tone rendering curve based on said acquired ambient light information, and image adjusting means for adjusting luminance values of pixels within said image according to said determined tone rendering curve. Said ambient light acquisition means may be a light sensor or any other device for detecting ambient light information.

Another aspect of the invention is a display device driver for driving a display device, comprising image analysing means for analysing image content, tone rendering curve determination means for determining a tone rendering curve based on said analysed image content, and image adjusting means for adjusting luminance values of image pixels within said image according to said acquired tone rendering curve.

A further aspect of the invention is a system for presenting images with improved quality to viewers comprising a pre-described display device, and an ambient light sensor for providing ambient light information, wherein said display device adjusts luminance values of pixels within said image according to a tone rendering curve determined at least partially from said ambient light information.

Yet, a further aspect of the invention is a computer program for driving a display device operable to cause a processor to perform a pre-described method, as well as a computer program product with such a computer program tangibly stored thereon.

These and other aspects of the invention will be apparent from and elucidated with reference to the following figures. In the figures shows

### BRIEF DESCRIPTION OF THE DRAWING

FIG. 1 a flow chart of an inventive method;

FIG. 2 a further flow chart of an inventive method;

FIG. 3 tone rendering curves;

FIG. 4 a display device according to the invention.

### DETAILED DESCRIPTION OF THE INVENTION

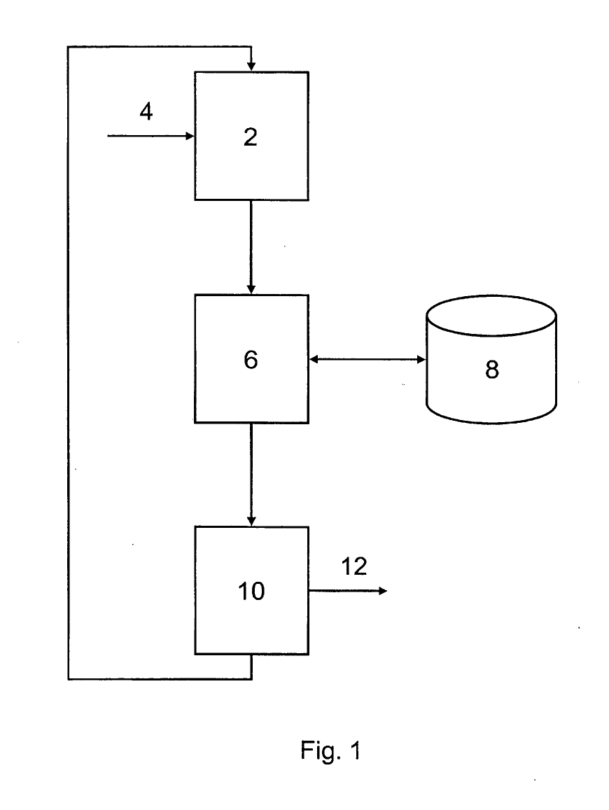

FIG. 1 depicts a flow chart of an inventive method. In step 2, an image input signal on a line 4 is analysed. During analysing the image input signal 4 in step 2, a brightness histogram of the image is calculated. Information resulting from this brightness histogram is processed in step 6 to determine a tone rendering curve which fits best for improving image quality. In the depicted method, different tone rendering curves are stored in storage 8. Nevertheless, it is also possible that in step 6 the brightness information retrieved from step 2 is used for calculating an individual tone rendering curve which fits best for the particular image.

As depicted, in step 6 the best fitting tone rendering curve is determined and retrieve from storage 8. Afterwards, in step 10 the image pixels are adjusted according to the tone rendering curve information. Adjusting the image pixels may result in a change of the luminance value of each pixel. This may be done by increasing or decreasing the luminance value. The tone rendering curve may be understood as a characteristic line determining how to adjust pixels of a certain values. After adjusting the image pixels, the improved image is provided as an output signal on a line 12. Then, steps 2 to 10 are repeated for the next incoming image from signal 4.

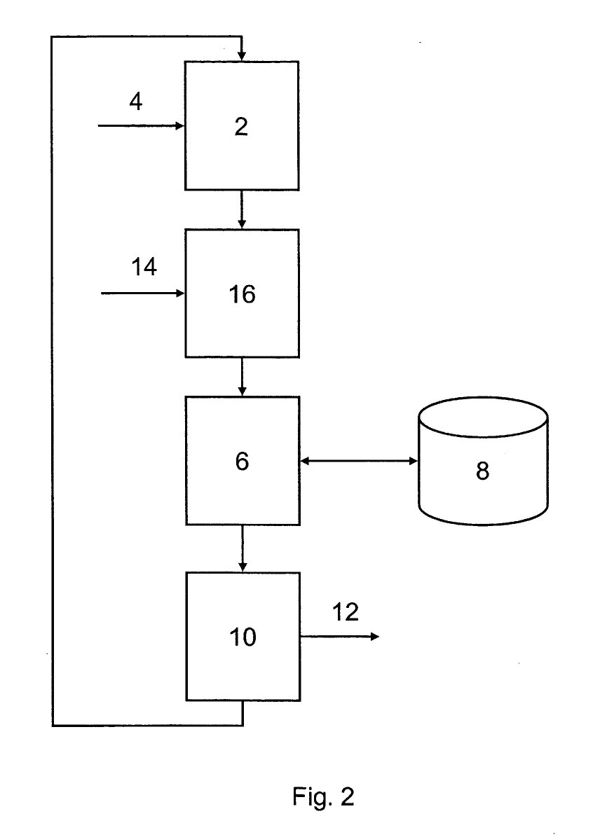

FIG. 2 depicts a further flow chart of an inventive method. Same reference signs refer to the same elements as in FIG. 1. After analysing in step 2 the input image, in step 16 an input signal on a line 14 from an ambient light sensor is acquired. An ambient light sensor senses light in the vicinity of the display and processes the result on the line 14 for acquisition of ambient light information 16. The information retrieved in steps 2 and 16 are processed to step 6, where an appropriate tone rendering curve is determined. This tone rendering curve depends on image properties, e.g. a brightness histogram of the image as well as ambient light information. The best fitting tone rendering curve is then retrieved from storage 8, and in step 10 the image pixels are adjusted according to the tone rendering curve. The resulting image is provided as an output signal on a line 12, and steps 2 to 16 are executed for the next image.

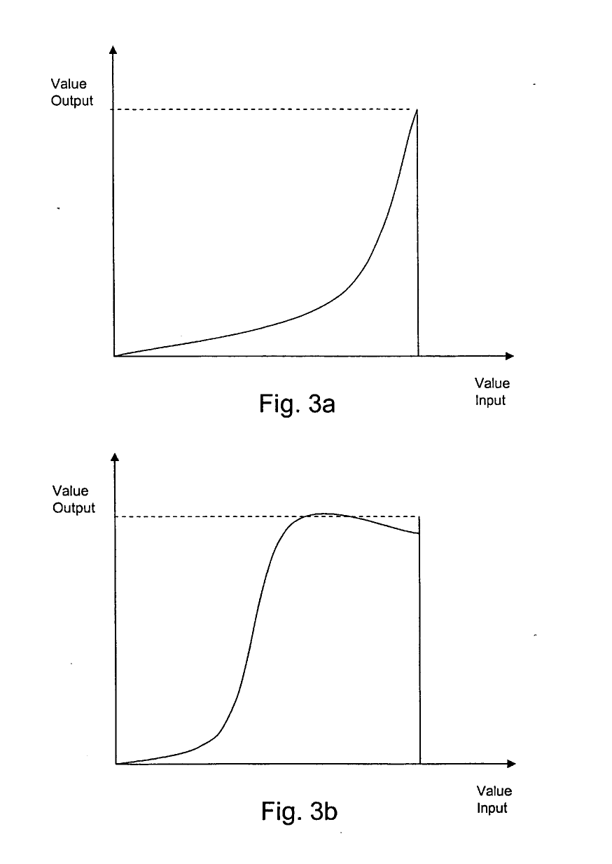

FIG. 3 depicts in FIG. 3a and 3b different tone rendering curves. The co-ordinate system provides on its abscissa a pixel input representing HSV colour system value. The ordinate represents the HSV colour system value output for the particular input pixel. As can be seen from the characteristic line of FIG. 3a, the value output is decreased for all value inputs. The decrease of value is largest for pixels with a medium value and becomes smaller with boundary values.

FIG. 3b depicts a different characteristic line of a tone rendering curve. Pixels with low value input are output with an even lower value, whereas pixels with a large value input are output with a larger value output. Tone rendering curves depicted in FIG. 3a and FIG. 3b do only represent exemplarily possible tone rendering curves. Any other characteristic lines of tone rendering curves are possible.

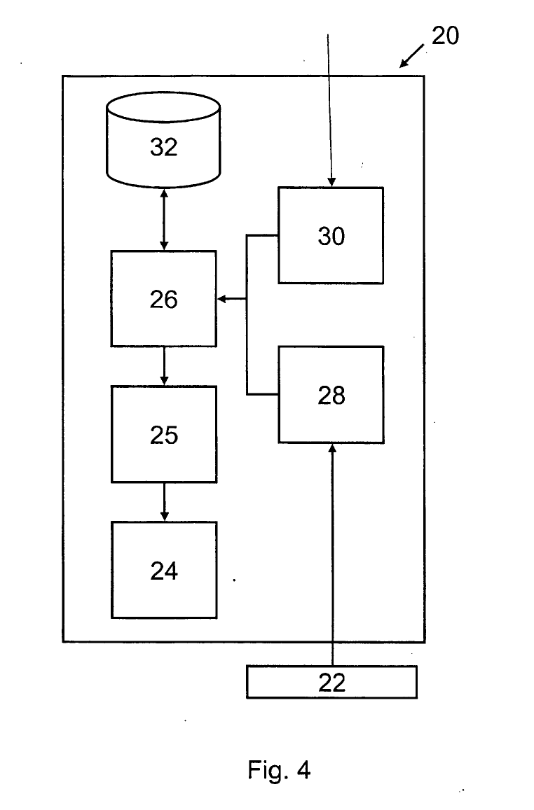

FIG. 4 depicts a display device 20 connected to an ambient light sensor 22.

Display device 20 comprises a screen 24, pixel adjustment means 25, tone rendering curve determination means 26, ambient light information acquisition means 28, image analysing means 30 and storage means 32.

Information acquired by ambient light sensor 22 is provided to ambient light information acquisition means 28. The acquired information is processed and provided to tone rendering curve determination means 26. Image analysing means 30 is provided with an image input signal. The image input signal is analysed and brightness information of an image is passed to tone rendering curve determination means 26. Said tone rendering curve determination means 26 determine the appropriate tone rendering curve using the ambient light information, and the brightness information provided by ambient light information acquisition means 28, and image analysing means 30, respectively. The appropriate tone rendering curve is retrieved from storage means 32 and provided to image adjustments means 25. Within image adjustment means 25, pixels are adjusted according to their value and the selected tone rendering curve. After adjusting the pixel brightness, the image is presented on screen 24.

By analysing the image, in particular brightness as well as the ambient light information, it is possible to select an appropriate tone rendering curve. It is also possible to use further information within tone rendering curve determination means 26. Such information may comprise setting of the display device 20, in particular colour, contrast, and brightness settings of the display device 20.

By manipulating image values using a tone rendering curve dynamically determined from image content, and ambient light information, it is possible to improve the perceived image quality. Viewers of this image have an impression of a higher quality image, as brightness of the image is dynamically adjusted.

1. A method for rendering images on display devices with improved quality with the steps of:
analysing at least partially contents of said image determining a tone rendering curve based on said analysed image content, and
adjusting luminance values of pixels within said image according to said determined tone rendering curve.

2. The method of claim 1, wherein luminance values of pixels are analysed for determining said tone rendering curve.

3. The method of claim 1, wherein an image histogram is analysed for determining said tone rendering curve.

4. The method of claim 1, wherein at least two different tone rendering curves are stored, and wherein said determined tone rendering curve is taken from said storage.

5. The method of claim 1, wherein said tone rendering curve is customized according to properties of said display device.

6. The method of claim 1, wherein said tone rendering curve is applied to said luminance values of pixels within an HSV or Lsα colour space.

7. The method of claim 1, wherein ambient light information is acquired, and wherein said tone rendering curve is also determined based on said ambient light information.

8. A method for rendering images on display devices with improved quality with the steps of:
acquiring ambient light information,
analysing said ambient light information,
determining a tone rendering curve based on said ambient light information, and
adjusting luminance values of pixels within said image according to said determined tone rendering curve.

9. A method for rendering images on display devices with improved quality with the steps of:
analysing at least partially contents of said image,
acquiring ambient light information,
determining a tone rendering curve based on said ambient light information, and said image content, and
adjusting luminance values of pixels within said image according to said determined tone rendering curve.

10. A display device for presenting images to viewers according to a method of claim 1, said display device comprising:
a screen for showing said image,
image analysing means for analysing at least partially contents of said image,
tone rendering curve determination means for determining a tone rendering curve based on said analysed image content, and
image adjusting means for adjusting luminance values of pixels within said image according to said determined tone rendering curve.

11. A display device for presenting images to viewers according to a method of claim 1, said display device comprising:
a screen for showing said image,
ambient light acquisition means for acquiring ambient light information,
tone rendering curve determination means for determining a tone rendering curve based on said acquired ambient light information, and
image adjusting means for adjusting luminance values of pixels within said image according to said determined tone rendering curve.

12. A display device for presenting images to viewers according to a method of claim 1, said display device comprising:
a screen for showing said image,
image analysing means for analysing at least partially contents of said image,
ambient light acquisition means for acquiring ambient light information,
tone rendering curve determination means for determining a tone rendering curve based on said analysed image content, and said acquired ambient light information, and
image adjusting means for adjusting luminance values of pixels within said image according to said determined tone rendering curve.

13. A display device driver for driving a display device according to claim 10, comprising:
image analysing means for analysing image content,
tone rendering curve determination means for determining a tone rendering curve based on said analysed image content, and
image adjusting means for adjusting luminance values of pixels within said image according to said acquired tone rendering curve.

14. A system for presenting images with improved quality to viewers, comprising:
a display device according to claim 10, and an ambient light sensor for providing ambient light information,
wherein said display device adjusts luminance values of pixels within said image according to a rendering curve determined at least partially by said ambient light information.

15. A computer program for driving a display device, or a display device driver, operable to cause a processor to perform a method according to claim 1.

16. A computer program product with a computer program according to claim 15 tangibly stored thereon.
